(19) United States
(12) Patent Application Publication
(10) Pub. No.: US 2003/0083789 A1
(43) Pub. Date: May 1, 2003

(54) Product training and demonstration software application

(76) Inventor: Terrence D. Kalley, Troy, MI (US)

Correspondence Address: FISH & RICHARDSON P.C., 1425 K STREET, N.W., 11TH FLOOR, WASHINGTON, DC, 20005-3500, US

(21) Appl. No.: 09/983,597

(22) Filed: Oct. 25, 2001

(51) Int. Cl. G06F 17/00

(52) U.S. Cl. 701/1

(57) ABSTRACT

An interactive demonstration system is provided to assist in training, marketing, and instructing users in the operation and use of products such as automobile diagnostic devices. Interactive simulations combine various forms of media to provide a virtual hands-on learning or evaluation experience.

### TECHNICAL FIELD

This invention relates to a technique for demonstrating and training in the use, operation, and/or repair of a device, such as, an air-conditioning diagnostic tester.

### BACKGROUND

The increasing complexity of common devices ever tilts a fine balance between the cost of repair and the cost of replacement. For example, televisions were once very expensive, yet somewhat unreliable. Vacuum tube entrails spurred the growth of a service industry to meet the ever-growing need to repair televisions. As manufacturing processes and technology developed, the costs of producing televisions dropped considerably as the complexity and reliability of the devices increased. Today, the cost of repair is so high that the demand for television repair is slight for all but the most expensive televisions.

Other service industries have experienced a different evolution in response to increased system complexity. For example, as the complexity of automotive systems has increased, the automotive maintenance and repair industry has evolved, providing complex tools and diagnostic systems to increase the efficiency and reduce the necessary skill level of technicians. Using an air-conditioning diagnostic tester, such as Bright Solutions' A/C Investigator, permit a relatively inexperienced technician with a rudimentary understanding of air-conditioning principles to effectively and efficiently diagnose an automotive air-conditioning system. Diagnostic repair equipment is often expensive and/or bulky; therefore, it may be difficult for sales, marketing, and training personnel to bring the equipment to potential customers and users for proper evaluation, training, demonstration, and the like.

For example, a potential customer may wish to evaluate an expensive device before deciding to make a purchase. The expensive diagnostic device may be too large and/or heavy to transport using inexpensive parcel carriers. Additionally, complex assembly and calibration may be necessary to prepare the device for use. To properly evaluate a system, the salesperson may desire to train technicians as to the proper use and advantages of the system. Such training may affect productivity by taking technicians away from profit generating work, and it may be very difficult to schedule a single time when key technicians can be trained to properly evaluate the product.

### SUMMARY

In a computer system including an input device and an output device, a method is provided for demonstrating an automotive diagnostic device. The method includes displaying a simulation of the use of the automotive diagnostic device using the output device, receiving input from the input device, and updating the simulation of the use of the automotive diagnostic device based on the input received from the input device.

In some implementations, the automotive diagnostic device is an air-conditioning automotive diagnostic device. Displaying a simulation of the use of the automotive diagnostic device may include displaying images describing how to connect the airconditioning automotive diagnostic device to an automobile. Additionally, the input device may include a mouse, a keyboard, a virtual reality glove, a virtual reality helmet, or a touchscreen display. The output device may include a liquid crystal display panel, an active matrix display, a printer; a light-emitting diode, a speaker, or headphones. Various implementations may quiz a user regarding the use of the automotive diagnostic device.

A computer system may be provided including demonstration software to provide an interactive simulation of a diagnostic device. The computer system includes an input device, an output device, a computer memory, a computer-readable storage device, and a processor. The processor is coupled to the computer memory and the computer-readable storage device and is configured to provide demonstration software including a user interface module and a simulation module. The user interface module receives input from the input devices and sends output to the output devices. The simulation module simulates the operation of the diagnostic device receiving input and sending output through the user interface module.

In some implementations, the diagnostic device is an automotive diagnostic device. For example, the automotive diagnostic device may be operable to diagnose problems with automotive air-conditioning systems.

The computer system may include input devices, such as a keyboard, a touch-screen display, or a mouse. The system may include output devices such as a computer display (e.g., liquid crystal display (LCD) panel or active matrix display), a printer, or a light-emitting diode (LED).

The simulation module may include a description module and a use module. Some implementations may also include a safety module. The description module may include a function description module, a specification module, and a product tour module. The use module may include a configuration module, an operation module, a result module, a troubleshooting module, and a maintenance module.

A method of marketing an automobile diagnostic device is provided. The method includes identifying a potential customer, and distributing an interactive simulation of the automobile diagnostic device to the identified potential customer. The potential customer can evaluate the automobile diagnostic device using the interactive simulation.

The details of one or more implementations are set forth in the accompanying drawings and the description below. Other features and advantages will be apparent from the description and drawings, and from the claims.

### DESCRIPTION OF DRAWINGS

FIG. 1 is a diagram of a technician using a diagnostic tool in the service, repair, and/or maintenance of an automobile.

FIG. 2 is a diagram of a technician using a demonstration software package accessing various computer networks and storage media.

FIG. 3 is a block diagram of a demonstration software package including various inputs, outputs, and storage devices.

FIG. 4 is a block diagram of a demonstration software system that may be used in the demonstration, evaluation, and/or training of the operation, use, service, and/or repair of a device.

FIG. 5 is a block diagram of a demonstration software system integrated with various software packages.

FIG. 6 is a screenshot of a demonstration software system graphical user interface providing a hands-on interactive simulation.

FIG. 7 is a block diagram of a simulation module for the demonstration, evaluation, and/or training of the operation, use, service, and/or repair of an air-conditioning system using a diagnostic device.

FIG. 8A is a flowchart of the operation of an exemplary demonstration software system.

FIG. 8B is a flowchart of the operation of an interactive simulation module in an exemplary demonstration software system.

FIG. 9 is a menu of various modules for an automobile maintenance and repair demonstration software system.

### DETAILED DESCRIPTION

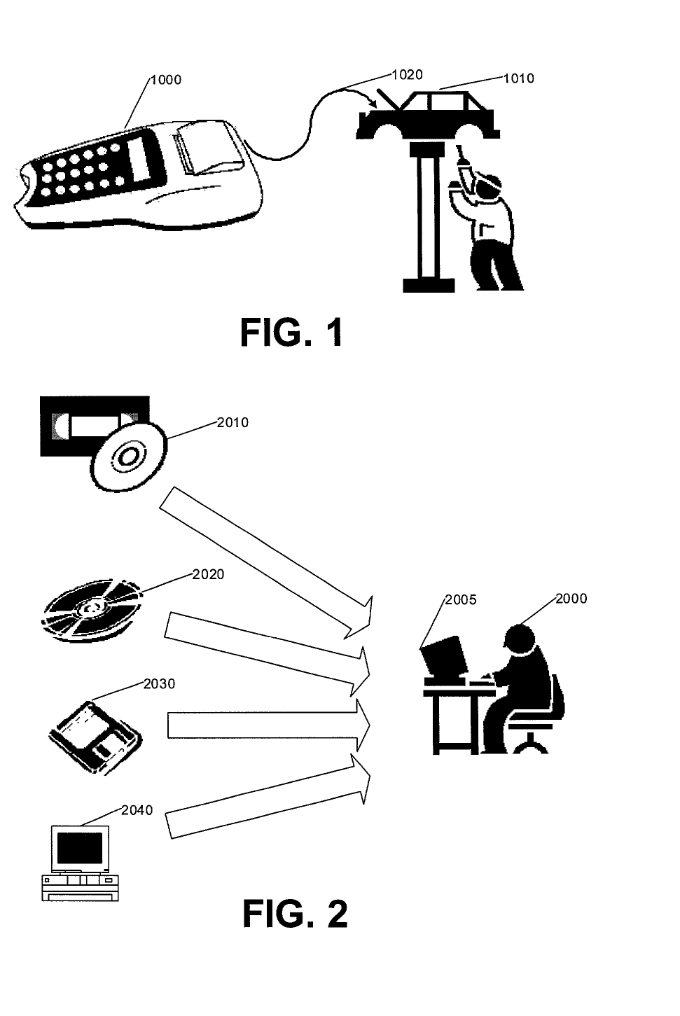

Referring to FIG. 1, diagnostic device 1000 may be used to assist automotive service technicians in the diagnosis, repair, and troubleshooting of automobile problems. For example, an automotive air-conditioning (A/C) diagnostic test tool can be used to identify and correct problems in cars and light trucks. One such diagnostic device 1000 used by technicians is Bright Solutions' A/C Investigator. Diagnostic device 1000 may be connected to automobile 1010 using one or more connections 1020. In an A/C diagnostic system, connections may include, for example, high-side pressure, low-side pressure, temperature at the center vent of the passenger compartment, electrical data from the high side cut-out or cycling switch of the compressor, ambient temperature, relative humidity, and temperatures from the inlets and outlets of heat exchangers and the compressor.

The diagnostic device 1000, using sophisticated computer software, may analyze input data from a user and from the one or more connections 1020 to diagnose A/C problems, printing out or displaying a list of possible problems and suggested repair solutions. For example, the printout may include a record of selected system temperatures, high and low pressures, and high and low pressure charts showing compressor cycling. Diagnostic device 1000 may increase profits for automotive service centers by decreasing diagnostic time while increasing the accuracy of the resulting diagnosis, which can free service bays, enhance technician capabilities, eliminate costly mistakes, lower warranty costs, and increase customer confidence by reducing return visits for the same problem caused by an incorrect diagnosis.

Diagnostic device 1000 provides a range of features and benefits that may not be immediately apparent to a repair technician. With service centers scattered across the country, traditional sales and marketing can prove costly, requiring highly trained sales individuals, many evaluation or sample diagnostic devices 1000, and high travel costs and expenses. In addition, it is difficult to schedule training of key technicians in the operation of the diagnostic device 1000.

Referring to FIG. 2, a service technician 2000 may use a demonstration software system 2005 as a training, use, and evaluation tool. This demonstration software system 2005 is a training, marketing, and user tool covering the service and repair of A/C systems using products such as diagnostic device 1000. Various implementations of demonstration software system 2005 may access programs and/or data stored on a storage medium (e.g., video cassette recorder (VCR) tape or digital video disc (DVD) 2010; compact disc (CD) 2020; or floppy disk 2030). Additionally, various implementations may access programs and/or data accessed stored on another computer system 2040 through a communication medium including a direct cable connection, a computer network, a wireless network, a satellite network, or the like.

The demonstration software system 2005 can be in the form of a software application running on any processing device, such as, a general-purpose computing device, a personal digital assistant (PDA), a special-purpose computing device, a laptop computer, a handheld computer, or a network appliance. The demonstration software system 2005 may consist of modules, which may be used independently or as an integrated package. The full system may represent a holistic approach to problem solving using interactive technologies. Each module can detail the service or repair of a different segment of a vehicle. For example, modules may be provided for A/C, brakes, tires, electrical, electronics, transmission, engine, muffler, body, and others.

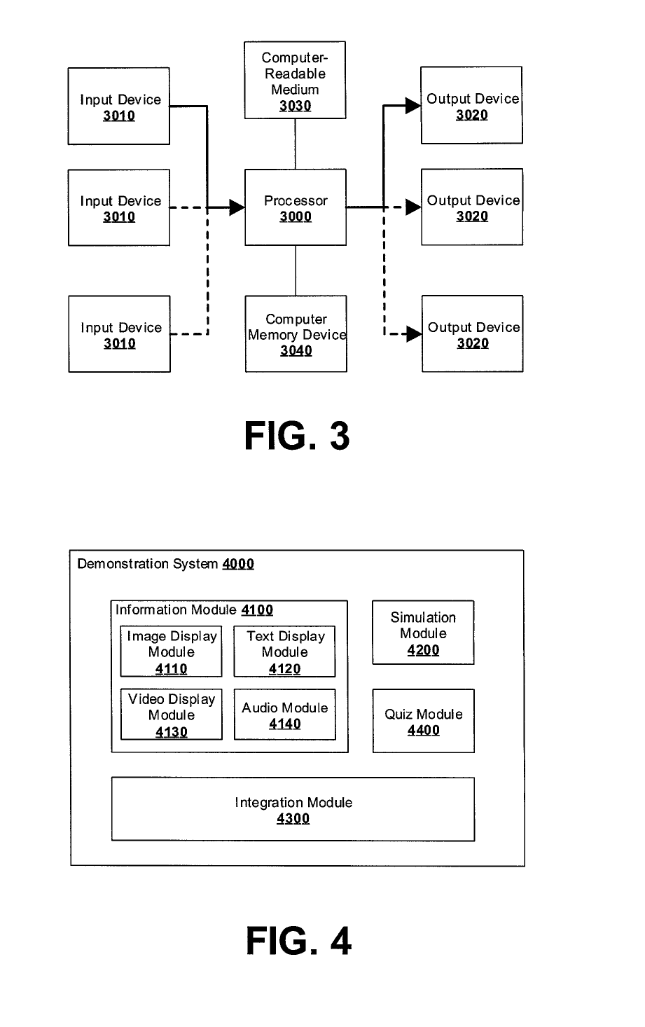

Referring to FIG. 3, a demonstration software system may be implemented using a hardware configuration including a processor 3000, one or more input devices 3010, one or more output devices, a computer-readable medium 3030, and a computer memory device 3040. The processor 3000 may be implemented using any computer processing device, such as, a general-purpose microprocessor or an application-specific integrated circuit (ASIC). Processor 3000 is integrated with input/output (I/O) devices to provide a mechanism to receive sensor data and/or input data and to provide a mechanism to display or otherwise output queries and results to a service technician. Input device 3010 may include, for example, one or more of the following: a mouse, a keyboard, a touch-screen display, a button, a sensor, and a counter.

Output device 3020 may be implemented using any output technology, including a liquid crystal display (LCD), a television, a printer, and a light emitting diode (LED). The computer-readable medium 3030 provides a mechanism for storing programs and data either on a fixed or removable medium. The computer-readable medium 3030 may be implemented using a conventional computer hard drive, or other removable medium such as those described above with reference to FIG. 2. Finally, the system uses computer memory device 3040, such as a random access memory (RAM), to assist in operating the demonstration system.

Additional input devices 3010 and output devices 3020 may include those typically used in virtual-reality applications such as gloves, helmets with heads-up displays, etc.

Referring to FIG. 4, implementations of a demonstration system 4000 include software that simulates the actions of a professional technician in servicing or repairing a product such as a vehicle. Many industries, which currently lack a systematic, integrated approach to problem solving, can use demonstration system 4000. This approach can integrate many digital technologies and can be used not only to guide users to optimize service procedures but also to record and track the entire service process.

Demonstration system 4000 includes one or more modules for implementing a user interface, simulating technician operations and procedures, quizzing the technician, and integrating with other systems. Information module 4100 implements a user interface system using the following sub-modules: image display module 4110, text display module 4120, video display module 4130, and audio module 4140. The image display module 4110 may be used to display images in various formats, for example, joint photographic experts group (JPEG) format, tagged image file format (TIFF), graphics interchange format (GIF), or bitmap.

Text display module 4120 may be used to display text messages, help messages, and various information to technicians. In some implementations, text display module 4120 supports the hypertext markup language (HTML) format such that displayed text may include hyperlinks to additional information, images, or formatted text.

Video display module 4130 provides a mechanism for displaying videos stored, for example in the moving picture experts group (MPEG) format, Apple's QuickTime format, or DVD format. Finally, audio module 4140 provides a mechanism to produce sounds, music, and the like.

Simulation module 4200 provides much of the “brains” of demonstration system 4000. This module determines the menus, images, text, and/or videos to be displayed using information module 4100. By providing user input information to simulation module 4200, an interactive learning environment can be provided to educate, train, or demonstrate products or techniques to service technicians. This module can be oriented to problem solving by guiding a user to answer questions, such as, how to identify a vehicle problem, how to operate a piece of service equipment, how to repair or replace a vehicle part, how to interpret a vehicle diagnostic report, or other pertinent questions.

To further enhance the interactive teaching capabilities of the demonstration system 4000, some implementations provide a quiz module 4400 to test technicians on key concepts to reinforce concepts and to ensure technician understanding. Quiz module 4400 may include many of the interactive features provided by simulation module 4200, testing a technician's grasp of the concepts in an interactive or virtual-reality simulation of real-world problems. In some implementations, the quiz module tests users knowledge automatically, for example, at the completion of any given module or unit. In such an implementation, a user can be automatically quizzed upon completion of a multimedia presentation regarding the operation of a diagnostic device. In some implementations, the user may be tested upon selection of the appropriate menu option.

Integration module 4300 allows demonstration system 4000 to be integrated with other applications, stored locally in the same system, or on remote systems across a direct connection or computer network. Thus, using this system, information may be presented to a user using words both written and narrated, drawings, computer-assisted design (CAD) drawings, hand-created renderings, photographs, video/film clips, music, sounds effects, etc.

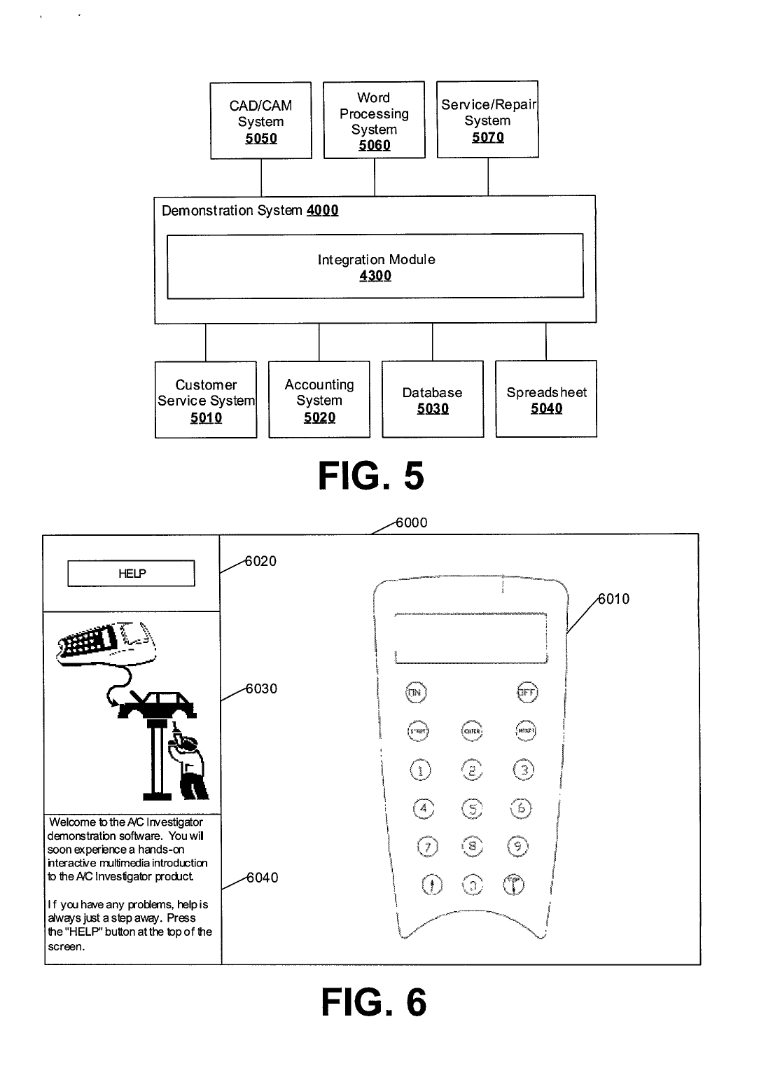

Referring to FIG. 5, integration module 4300 may provide access to applications such as customer service system 5010, accounting system 5020, database 5030, spreadsheet 5040, CAD/CAM system 5050, word processing system 5060, or other service/repair systems 5070 used in the operation, service, or repair of products. Demonstration system 4000 may also have the ability to go online, integrating existing databases and linking other websites. Online access may also provide remote, online access by technicians and by the owners of the products being serviced or repaired.

Referring to FIG. 6, one implementation of demonstration system 4000 provides training, guidance, and evaluation of the A/C Investigator diagnostic device discussed above with reference to FIG. 1. This system includes a graphical user interface 6000 with a simulation window 6010, a menu window 6020, a display window 6030, and a text window 6040. In this implementation, simulation window 6010 shows a representation of an A/C Investigator diagnostic device, including a display screen and several input buttons. The simulation window 6010 updates the displayed representation of the A/C Investigator to provide interactive, virtual reality simulation of the actual use of an A/C Investigator.

Menu window 6020 may provide one or more input buttons, such as a “Help” button, “Main Menu” button, and/or “Quit” button. These buttons may respond to mouse-clicks, touch-screen display input, or other inputs. For example, a “Help” button may be configured to display a static help screen or context-sensitive help to assist a technician in understanding and using the system.

Display window 6030 provides a graphical display of information, usually corresponding to information displayed in the simulation window 6010. For example, the system may provide a picture or animated display showing the various connections between a diagnostic device and an automobile. In some implementations, an MPEG or QuickTime video may be shown illustrating and explaining various steps to be taken by a technician in the operation of a diagnostic device.

Text window 6040 is used to display text that may correspond to information shown in other windows. In some implementations, text window 6040 displays only simple text messages; however, additional implementations allow the display of hypertext market language (HTML) messages similar to a web browser. These messages may be formatted and may include hyperlinks, images, or the like.

The exemplary implementation described with reference to FIG. 6 provides a vehicle/product split screen such that a diagnostic product and an automobile may both be viewed simultaneously. The system may also provide mouse dragging for attachments, help screen for keywords, and a helpful hints/operating & safety warnings box. The system can simulate vehicle problems (alter inputs) showing solution options (varied outputs). Additionally, the system can quiz a user asking for solutions to simulated problems.

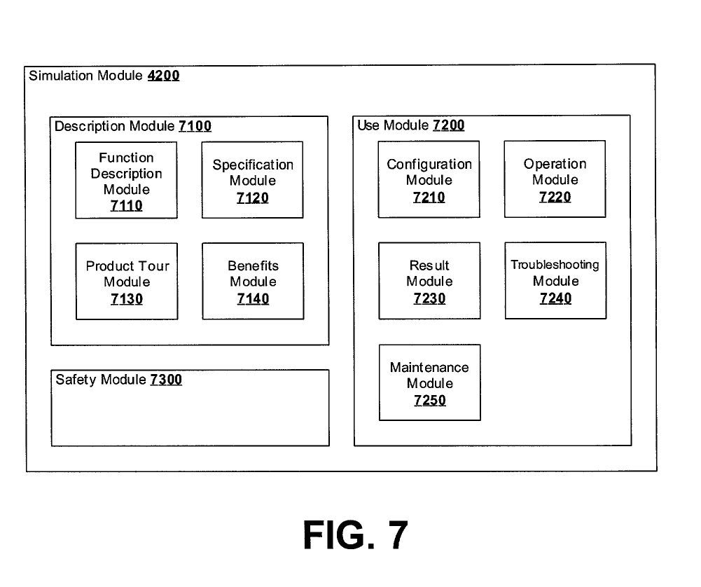

Referring to FIG. 7, an A/C Investigator demonstration system may include simulation module 4200. In some implementations, simulation module 4200 includes a description module 7100, a use module 7200, and a safety module 7300 corresponding to three general goals of one demonstration system: describing a diagnostic device, illustrating the use and operation of that device, and pointing out safety features and concerns associated with that device. These modules are given by way of example only. Other implementations may provide the same functionality in a monolithic design without dividing the system into discrete modules.

The description module 7100 includes a function description module 7110, a specification module 7120, a product tour module 7130, and a benefits module 7130. The function description module 7110 provides a component describing the functionality of diagnostic device. For example, the function description module 7110 may describe the features of the A/C Investigator.

The specification module 7120 provides a detailed description of the diagnostic device. For example, the specification module 7120 may identify systems compatible with the A/C Investigator, the compressor types that work with the A/C Investigator, warranty information, power requirements, or dimensions and weights of the tester.

The product tour module 7130 provides a possibly interactive tour of the diagnostic device. In some implementations, a video may be shown describing the features of the device. For example, the video may show how to load batteries, recharge batteries, turn on the device, attach connectors, and so on.

Finally, the benefits module 7140 completes the description of the diagnostic device by emphasizing the benefits and advantages of the diagnostic device. Implementations may describe, for example, the benefits of the device through a video clip, or by listing the benefits individually.

The use module 7200 includes a configuration module 7210, an operation module 7220, a result module 7230, a troubleshooting module 7240, and a maintenance module 7250. The configuration module 7210 describes the initial setup, calibration, and configuration of a diagnostic device, while the operation module 7220 describes the use and operation of the diagnostic device. For example, operation module 7220 may describe the connection or hookup of a diagnostic device to an automobile.

The result module 7230 describes output information that may be obtained through application of the procedures described by the operation module 7220. This module may include descriptions of results that may be obtained as well as the interpretation of those results.

The troubleshooting module 7240 provides information regarding common problems that may be encountered, and the maintenance module 7250 describes any maintenance that may be required in operating, storing, repairing, and otherwise using the diagnostic device. Finally, the safety module 7300 identifies any safety issues that a technician needs to identify to ensure the safe, correct operation of the diagnostic device. For example, the safety module may provide information on pertinent environmental or regulatory issues. Some implementations may provide information on the safe disposal and handling of refrigerants such as chlorofluorocarbons to prevent their release into the atmosphere.

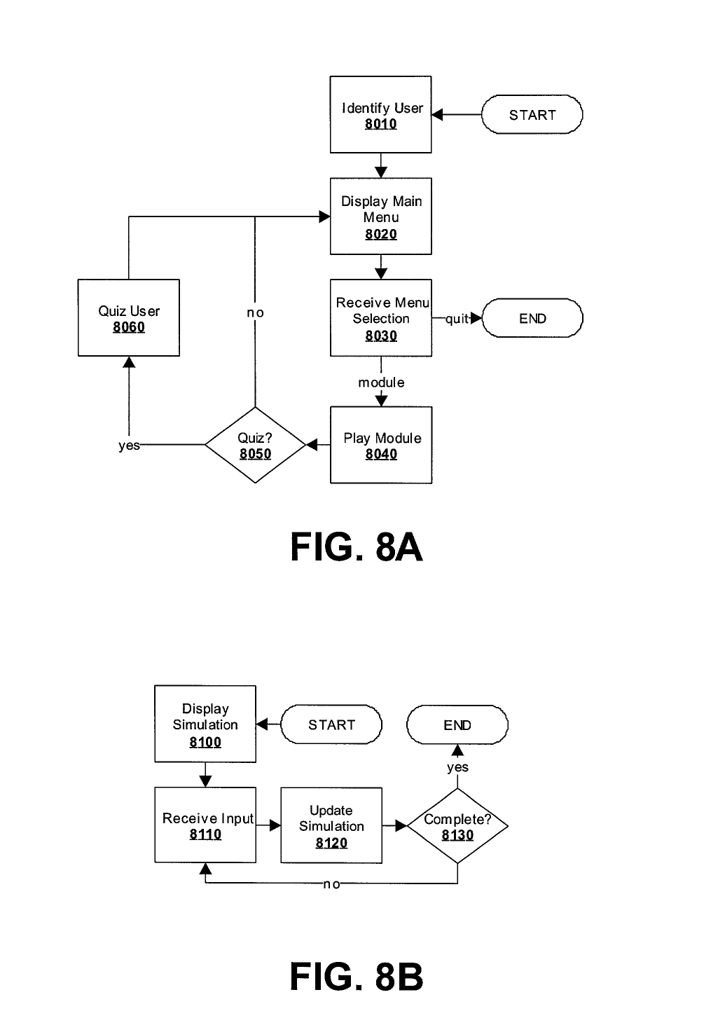

Referring to FIG. 8A, some implementations of demonstration systems may begin by identifying a user (step 8010). This information may be used to track the progress of a user through the various modules within the system and to record the quiz results to gauge the user's understanding. By tracking user information, users may be certified after completing the system and employers may track compliance with training objectives.

Once a user has been identified, the system displays the main menu (step 8020) identifying various modules that may be completed. Once the user selects an option from the main menu, the system receives the menu selection (step 8030) and processes the option. If the user selects to quit, the system exits. Otherwise, the selected module is played (step 8040).

When a module has been completed, the system determines whether the user would like to take a quiz (step 8050) on the subject matter contained in the module. If the user selects to take the quiz, then the system quizzes the user (step 8060), records the results, and returns to the main menu (step 8020). If the user decides not to take the quiz, then the system simply returns to the main menu (step 8020). This process continues until the user exits the system.

Referring to FIG. 8B, playing a module as described above with respect to step 8040 of FIG. 8A may include displaying a simulation (step 8100), and then successively receiving input (step 8110), updating the simulation (step 8120), and determining if the simulation is complete (step 8130). If the simulation is complete, the system exits. Otherwise, the process continues by again receiving user input (step 8110) if it is available.

Due to technological change and advancement, many industries lack technicians with the skills and knowledge to repair malfunctioning or damaged products. The money, equipment, and time needed to train these technicians may be lacking. Sometimes training involves time away from the job and travel. An interactive demonstration software application can allow training to take place at the user's computer at a time that is convenient to the user. Users can train themselves at their own pace and review topics not previously mastered.

Users may be trained through hands-on usage of repair equipment, training in a classroom setting with a combination of board (written) or projected (overhead) information, the use of videos, on-line training and the use of instruction manuals in printed or CD-ROM format. These approaches are sometimes costly and cumbersome when it is necessary to physically move repair equipment or the product in need of repair to a training site. Once the equipment is there, hands-on instruction requires the presence of an instructor. The number of technicians that can train on equipment simultaneously is often limited, often to just one user at a time.

While videos are sometimes cheaper and more amenable to a user's schedule, they are not typically interactive. Manuals that are in printed form lack any hands-on possibilities and lack the capabilities of sound, motion, interactivity, and user input.

It is possible to provide a teaching mechanism that is capable of sound, print, motion, and interactive learning. For example, a demonstration software package consisting of software contained on a disk of some type such as a drive, CD-ROM, or DVD used on a computer or another digital device accessible online may be used to provide a multi-faceted learning tool. However, if the application is used to add motion and sound to an existing instruction manual, it may lack the interactive instruction needed to learn hands-on skills. It may be useful to simulate the many facets of the repair process through the creation of a virtual reality mechanism that the user can have the look and feel of the service process without the need to train on the actual equipment. By using additional features of the program, the user can receive many benefits beyond those available only by training on the equipment.

In addition to training, various implementations of demonstration software may also be beneficial in sales. The complexity of marketing repair and service tools and equipment increases with the complexity of demonstrating the operation of such tools and equipment. The costs of demonstrating the operation of such items also rise if they are large, heavy or expensive to give to salespersons. The cost of marketing these items also rises as the target market increases in geographical scope and as the number of languages in which product demonstrations must occur also rises.

Demonstration software can decrease costs of marketing products that have historically been sold through hands-on demonstrations, thus relieving the marketer of added costs for on-site demonstration including sample costs, travel time, freight costs, and the remuneration of salespersons.

Additionally, demonstration software allows potential purchasers to evaluate products at a time and location of their own choosing through the simulation aspects of the program, thus abating the necessity of bringing certain products that may be bulky to trade shows. Instead a laptop computer connected to a monitor may be used to run demonstration software providing a virtual hands-on experience.

An implementation of demonstration software for the A/C Investigator diagnostic device described above, may include a module describing how to connect the tester to a vehicle. A combination of video, audio, and text may be used to describe the attachment of various sensors. For example, as a video is displayed, text and/or audio may instruct a user as follows: “Attach a Purge-Mate fitting to the low-pressure connection at the back of the tester.” As the video illustrates the action being performed, the text and/or audio continues: “Connect the gray low-pressure capillary line to the Purge-Mate fitting.” The module further describes the procedures necessary to connect the low-pressure line. Upon completion, the system can automatically quiz the user regarding the procedure. The demonstration software may simulate A/C problem conditions to teach a user how to properly and efficiently diagnose, service, and repair an automobile air-conditioner.

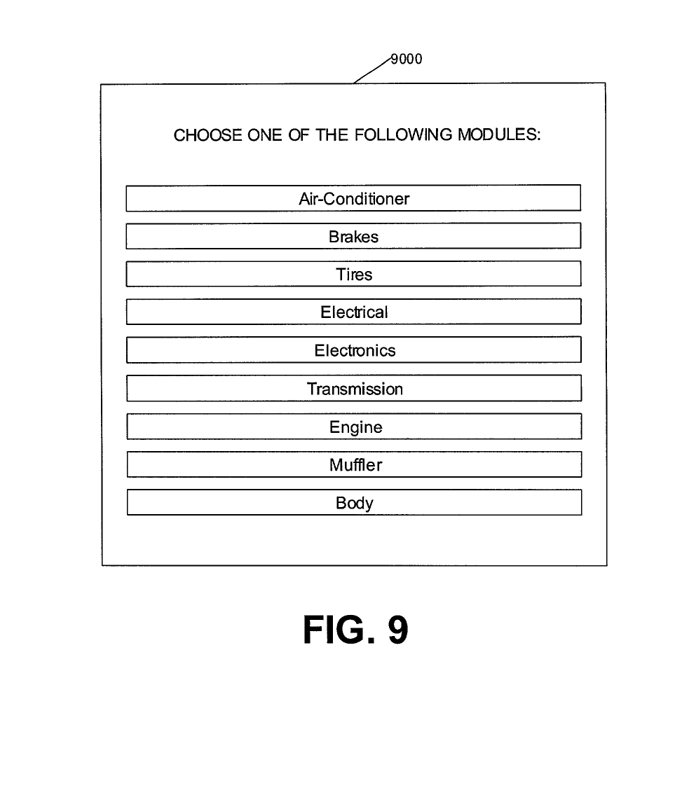

Referring to FIG. 9, the demonstration software described above has broad applicability in the automobile service industry. For example, one application includes modules to train service technicians in many aspects of automotive maintenance and repair. FIG. 9 illustrates a menu in an exemplary demonstration system providing modules on airconditioning, brakes, tires, electrical systems, electronics, transmissions, engines, mufflers, and automobile bodies. Additional implementations may provide modules for emission controls, power trains, and chassis repair and maintenance.

The system may provide many of the same benefits of hands-on usage that would not otherwise be possible in person due to the costs of travel to many disparate locations, and the costs of providing samples for training of expensive items. Additionally, the product helps overcome a lack of sales expertise to reach a fragmented target market. The products are sometimes big or heavy—it's much easier to move digits than atoms.

This method improves upon video learning systems, integrating many media for easy/explicit leaming. The demonstration system allows new species of product to be “used” (simulated) prior to purchase and allows off-site, distant, or after-hours training. Finally, the demonstration system may be used in combination with an actual instructor in a classroom environment.

While some of the examples discussed above pertain to a particular A/C diagnostic tester, the techniques presented are equally suited to any sort of maintenance or repair system, such as a diagnostic tester, fluorescent leak detection system (i.e., dyes, injection system, lights), electronic leak detection system, recovery and recycling machine radiator service device, refrigerant identification tester, or flushing system (both machine & product). Implementations may, for example, demonstrate the use of devices, the repair of devices, or the repair of a vehicle.

Additionally, the demonstration system may be used to simulate the use of tools for taking temperature or pressure readings of a system using manifold gauge sets, temperature probes, or electronic pyrometers; the use of tools for replacing, removing, or repairing systems or components; the use of tools for determining correct charge of an A/C system; digital volt/ohm meters; evacuation pumps to remove air and moisture from an A/C system; in-line filter installation; A/C parts installation, removal, and repair; or radiator repair and service.

The same techniques may also be used to train users in methods of A/C service including, for example: (1) how to find a leak in an a/c system; (2) how to measure the pressure in an A/C system; (3) how to remove moisture from an A/C system; (4) how to remove/recover/recycle/recharge refrigerant from/into an A/C system; (5) how to determine the type and quantity of refrigerant in an A/C system; (6) how to add compressor oil to an A/C system; (7) how to test for electrical problems; or (8) how to remove odor from an a/c system.

Various demonstration systems may be used to diagnose, repair, and replace any components of an A/C system including the following: (1) tube & fin serpentine, tube & fin parallel flow, flat tube, flat tube serpentine flow, flat tube multi-pass parallel flow, and flat tube parallel flow condensers; (2) single-pass and multi-pass evaporators; (3) piston type, axial type, radial type, scroll type, and rotary vane type compressors; (4) internally and externally equalized thermal expansion valves; (5) “H” valves and block valves; (6) orifice tubes (e.g., automatic adjusting orifice tubes); (7) receiver driers; (8) accumulators; (9) hoses and lines; (10) temperature sensors; (11) mechanical controls such as pressure cycling switches, thermostatic switches, high or low-pressure cutoff switches, compressor temperature switches, condenser fan switches, and A/C clutch relays; (12) computer A/C controls such as ambient temperature sensors, A/C pressure sensors, evaporator temperature sensors, coolant sensors, throttle position switches, and power steering pressure sensors; or (13) A/C filters.

Additional implementations may provide instruction based on customer complaints such as the following: (1) no cooling; (2) insufficient cooling; (3) noises; (4) excessive temperatures and pressures; (5) air in the A/C system; or (6) contaminants in system. Modules may also be provided to describe how to differentiate different types of noises emanating from an A/C system and use those noises as an additional diagnostic tool.

Some implementations of a demonstration system may include network access integrating an entire A/C service center. The system can guide technicians through service procedures, describing the procedures and use of requisite tools and equipment. The system may be integrated with various databanks including information on part numbers and replacement parts.

Various implementations additionally provide live on-line help. Such that a service technician can ask questions of a customer-service representative through voice, video, and/or text messaging by selecting to obtain on-line help.

Accordingly, other implementations are within the scope of the following claims.

What is claimed is:

1. In a computer system including an input device and an output device, a method of demonstrating an automotive diagnostic device, the method comprising:
displaying a simulation of the use of the automotive diagnostic device using the output device;
receiving input from the input device; and
updating the simulation of the use of the automotive diagnostic device based on the input received from the input device.

2. The method of claim 1 wherein the automotive diagnostic device is an air-conditioning automotive diagnostic device.

3. The method of claim 2 wherein displaying a simulation of the use of the automotive diagnostic device includes displaying images describing how to connect the air-conditioning automotive diagnostic device to an automobile.

4. The method of claim 1 wherein the input device includes a mouse, a keyboard, a virtual reality glove, a virtual reality helmet, or a touch-screen display.

5. The method of claim 1 wherein the output device includes a liquid crystal display panel, an active matrix display, a printer, a light-emitting diode, a speaker, or headphones.

6. The method of claim 1 further comprising quizzing a user regarding the use of the automotive diagnostic device.

7. In a computer system, demonstration software providing an interactive simulation of a diagnostic device, the computer system comprising:
an input device;
an output device;
a computer memory;
a computer-readable medium; and
a processor coupled to the computer memory and the computer-readable medium, the processor configured to provide demonstration software including:
a user interface module receiving input from the input device and sending output to the output device; and
a simulation module simulating the operation of the diagnostic device,
wherein the simulation module receives input through the user interface module and sends output through the user interface module.

8. The computer system of claim 7 wherein the diagnostic device is an automotive diagnostic device.

9. The computer system of claim 8 wherein the automotive diagnostic device is operable to diagnose problems with automotive air-conditioning systems.

10. The computer system of claim 7 wherein the input includes a keyboard.

11. The computer system of claim 7 wherein the input includes a touch-screen display.

12. The computer system of claim 7 wherein the input includes a mouse.

13. The computer system of claim 7 wherein the output includes a computer display.

14. The computer system of claim 13 wherein the computer display is a liquid crystal display panel.

15. The computer system of claim 13 wherein the computer display is an active matrix display.

16. The computer system of claim 7 wherein the output device includes a printer.

17. The computer system of claim 7 wherein the output device includes a light-emitting diode.

18. The computer system of claim 7 wherein the simulation module comprises:
a description module; and
a use module.

19. The computer system of claim 18 wherein the simulation module further comprises a safety module.

20. The computer system of claim 19 wherein the description module comprises:
a function description module;
a specification module; and
a product tour module.

21. The computer system of claim 18 wherein the use module comprises:
a configuration module;
an operation module;
a result module;
a troubleshooting module; and
a maintenance module.

22. A method of marketing an automobile diagnostic device comprising:
identifying a potential customer; and
distributing an interactive simulation of the automobile diagnostic device to the identified potential customer,
whereby the customer can evaluate the automobile diagnostic device using the interactive simulation.

23. The method of claim 22 wherein the automobile diagnostic device is an air-conditioning diagnostic device.
